(19) United States
(12) Patent Application Publication
(10) Pub. No.: US 2022/0014580 A1
(43) Pub. Date: Jan. 13, 2022

(54) Smart Storyboard for Online Events

(71) Applicant: Omnovia Technologies Inc., Lafayette, CA (US)

(72) Inventors: Shahin Shadfar, Lafayette, CA (US); Belal Atiyyah, London (GB)

(21) Appl. No.: 17/146,321

(22) Filed: Jan. 11, 2021

Related U.S. Application Data
(60) Provisional application No. 63/049,068, filed on Jul. 7, 2020.

(51) Int. Cl. H04L 29/06; H04N 7/15; G06F 3/0481

(52) U.S. Cl. CPC H04L 65/602; H04N 7/155; H04L 65/403; H04L 65/1089; G06F 3/04817

(57) ABSTRACT

In one embodiment, a method includes displaying in a user interface of a computing device, multiple content block objects of an online event and an interactive element to begin the online event in sequential order. Each content block object includes a content object type and content associated with the content block object. The method includes receiving a selection of the interactive element to begin the online event. The method includes causing the content associated with a first content block object to be displayed through an audio-video communication session, the first content block object being first in the sequential order. The method includes, upon completion of the content associated with the first content block object, causing the content associated with a second content block object to be displayed through the audio-video communication session, the second content block object being after the first content block object.

### PRIORITY

This application claims the benefit, under 35 U.S.C. § 119(e), of U.S. Provisional Patent Application No. 63/049,068, filed 7 Jul. 2020, which is incorporated herein by reference.

### TECHNICAL FIELD

This disclosure generally relates to presentation of content during online events.

### BACKGROUND

A “webinar” is typically considered a live or pre-recorded online video-conference where one or more presenters may speak on a topic. The speakers may include visual aids, such as presentation slides, to facilitate the discussion and improve audience engagement and retention of the presented information. Typically, the content of the visual aids is advanced, such as presenting the next in a series of presentation slides, by a single presenter who controls the visual aid and manages the audio-video stream. When a new presenter wishes to take over the presentation, they must ensure that the audio and video hardware of the computing device is properly configured to allow for them to present. The presenter must also either request control of the presentation through the video-conferencing software or must instruct the presenter controlling the visual aids when to advance the material interrupting the flow the presentation, distracting the audience and lowering the quality of the presentation overall. Audience engagement is typically measured by requesting feedback from video-conference attendees after completion of the video-conference or by requesting attendees to interact with the video-conference through a third-party function. These approaches typically have low take-up rate, as most attendees are not incentivized to take additional time to provide feedback. There is thus a need for advanced methods for facilitating the presentation of materials for a video-conference presentation and collecting of engagement metrics.

### SUMMARY OF PARTICULAR EMBODIMENTS

In particular embodiments, a method includes a computing device displaying, in a user interface, multiple content block objects that together make up an online event and an interactive element to begin the online event. Each content block object includes a content object type and content associated with the content block object. The content block objects may be displayed in a sequential order. The computing device may receive a selection of the interactive element to begin the online event. The computing device may cause the content associated with a first content block object to be displayed through an audio-video communication session, the first content block object being the first in the sequential order. Upon completion of the content associated with the first content block object, the computing device may cause the content associated with a second content block object to be displayed through the audio-video communication session, the second content block object being after the first content block object in the sequential order.

In particular embodiments, the method may include the computing device receiving, through the user interface, a specification of a new content block object to be added to the content block objects that make up the online event. The specification of the new content block object can include a content object type, content associated with the new content block object, and a position of the new content block object in the sequential order of the plurality of content block objects. The computing device can update the user interface to include the new content block object at a location corresponding to the position of the new content block object in the sequential order.

In particular embodiments, each content block object can be associated with a presenting user(s). The method may include, upon causing the content associated with a first content block object to be displayed through the audio-video communication session, facilitating audio or video associated with the presenting user associated with the first content block object to be transmitted through the audio-video communication session, or causing an icon corresponding to the presenting user to be displayed through the audio-video communication session. The may include, facilitating audio or video associated with the presenting user associated with the second content block object to be transmitted or causing the icon corresponding to presenting user to the displayed when the content associated with the second content block object is displayed through the audio-video communication session. In particular embodiments, facilitating audio or video associated with the presenting user to be transmitted through the audio-video communication session includes configuring a computing device of the presenting user to capture audio or video data in an environment of the presenting user and configuring the computing device of the presenting user to transmit the captured audio or video data through the audio-video communication session.

In particular embodiments, while the content associated with the first content block object is displayed through the audio-video communication session, the computing device may collect data associated with one or more participants in the audio-video communication session. The computing device can associate the collected data with the first content block object in a database maintained by the computing device. In particular embodiments, the computing device can retrieve the collected data associated with each content block object of the online event from the database and calculate an engagement score for the online event as a weighted combination of scores generated based on the collected data. In particular embodiments, the computing device can calculate an engagement score for each content block object of the online event, where the engagement score for each content block object is based on the content type of the content block object. In particular embodiments, a type of data collected for each content block object can be based on the content type of the content block object. In particular embodiments, each content block object can further include a user-notifier, that indicates a user to be notified when updated data is collected. Upon associating the collected data with a content block object in the database the computing device can send a notification of new data to a computing device associated with the user indicated in the user-notifier of the first content block object. In particular embodiments, the content object type can be one or more of the slide-type content, survey-type content, media-type content, screen sharing-type content, presenter feed-type content, or whiteboard-type content. In particular embodiments, the online event can be a video conference, a webinar, a trade show, a mixed-attendance conference, a concert, or a virtual-reality event.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIGS. 1A-1B illustrate an example interface of a smart content presentation system.

FIG. 2 illustrates an example interface of the smart content presentation system.

FIGS. 3A-3B illustrate an example interface for selecting content using the smart content presentation system.

FIG. 4 illustrates an example interface of the smart content presentation system.

FIGS. 5A-5B illustrate an example attendee interface of the smart content presentation system.

FIG. 6 illustrates an example interface of the smart content presentation system.

FIGS. 7A-7B illustrate an example interface for recoding content using the content presentation system.

FIGS. 8A-8B illustrate an example interface for recording content using the content presentation system.

FIGS. 9A-9I illustrate example interfaces for customizing and reviewing metrics collected by the content presentation system.

FIG. 10 illustrates an example computer system.

### DESCRIPTION OF EXAMPLE EMBODIMENTS

A smart content presentation system or “smart storyboard” is an online organizational tool where content for live or pre-recorded, online events may be created, managed collaboratively, automated and run. The online event may comprise presentation of certain specified content by a first group of users (e.g., “presenters”) to a second group of users (e.g., “attendees”) through an audio-video communication session. Through the smart storyboard, different types of content (slides, videos, webcams, surveys etc.) may be created in organized blocks of like content (e.g., “content blocks”). The different types of content may be edited and arranged sequentially just as a movie director might edit a variety of scenes to create a complete movie. In particular embodiments, a variety of automatic behaviors may be tied to content blocks. The use of content blocks may improve over previous approaches to presenting online events by creating a library of content blocks built into the smart content presentation platform and made available for immediate selection. The event organizer or presenters can deliver the content sequentially or change the order during the live event. Pre-loading content blocks and pre-assigning presenters allows for a seamless, professional choreography and delivery of the online event. Additionally, the smart content presentation system can improve the operations of computing systems while presenting or attending online events by providing additional functionality and reducing the interactions and coordination required to present a online event. For example, as discussed herein, the smart content presentation system can cause audio and video capture devices of online event presenters to automatically activate and deactivate when needed (or not) improving the presenting and receiving experience and making more efficient use of the audio and video capture devices. This is particularly important for presenters with less experience with the platform and with technology overall. Using the techniques described herein, presenters do not have to worry about the setup of their content because it can be uploaded and managed by another user, such as the event organizer, with the presenter's microphone and camera automatically activated (e.g., brought on air) when it is their turn to speak. This allows the present to focus solely on their content.

In particular embodiments, an “online event” as described in this disclosure can include a wide array of live or pre-recorded events that are facilitated with at least some component of the event occurring through telecommunication technology or over the internet. As an example only, and not by way of limitation, an online event can include an interactive conversation between one or more people where all attendees are in separate locations. This type of presentation can occur, for example in a standard video conference. As another example, a video conference can include remote teaching or exam proctoring, where one or more teachers are overseeing the work of several students. An online event can include a webinar, where one or more people are providing information in a largely one-directional manner to one or more attendees. Such a webinar can include one or more “main” or “keynote” events attended by most attendees as well as several breakout and plenary events attended by a subset of the attendees of the main event. Webinars and video conferences can have varying degrees of interactivity through the presentation of particular interactive content. As an example, an online event can include an individual streaming multimedia or interactive content, such as a video game, to one or more viewers. The presenter can allow some of the viewers to participate or influence the game. In addition, an online event can include an event where a portion of the attendees are attending the event in person while another portion are attending online. For example, a trade show or conference can include in-person participants as well as online participants viewing the same content or presentation provided by one or more speakers. The in-person and online participants can be encouraged to participate, for example, in breakout rooms or events. An online event can include events that are primarily occurring in person, with an online component included to allow for remote participation. For example, a music festival or concert may be held where some or all of the music acts are streamed, live or with a delay, to viewers online. As another example, a company can provide a mixed attendance online event for a annual general meeting, with secure voting on shareholder proposals being provided through the online event infrastructure. Additionally, any of the above variations of an online event can include augmented or virtual reality components, where one or more presenters or attendees are interacting with presented content or other attendees in a virtual space. As another example, an online event can include a guided or facilitated walkthrough of a three-dimensional space, such as a travel agent presenting a hotel room for booking to a client or a real estate agent showcasing a home remotely for a prospective purchaser. The techniques disclosed herein are equally applicable to such online events.

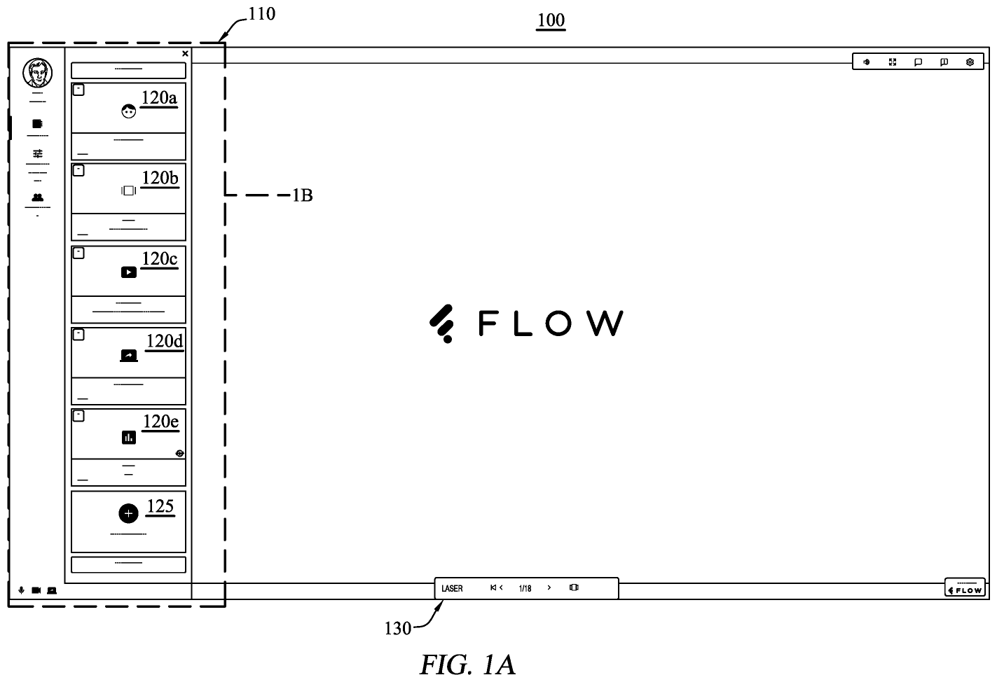

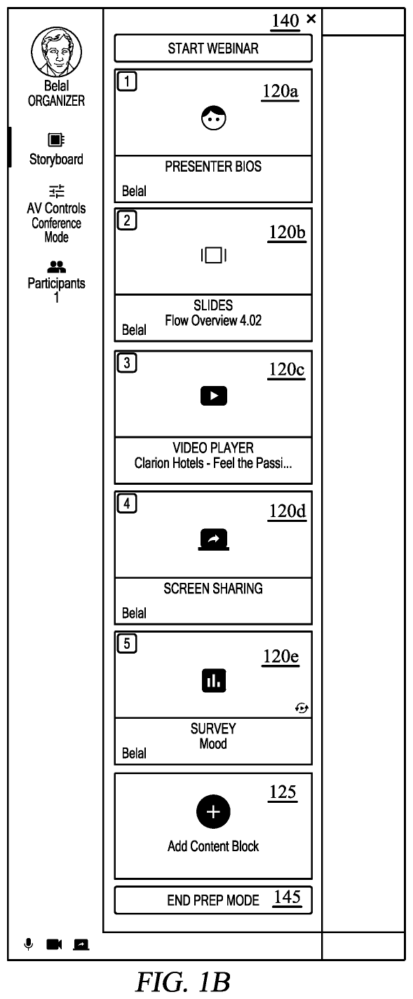

FIGS. 1A and 1B illustrate an embodiment of an interface 100 of the smart storyboard system. As an example and not by way of limitation, FIGS. 1A and 1B are illustrative of two types of users defined with different permissions in the smart storyboard. A first type of user, an “organizer” may have complete control to create, edit, events and content blocks. A second type of user, a “presenter” may not have permission to modify content blocks other than their own. A presenter may however view the smart storyboard as an outline of the event, allowing for separation of responsibilities. Presenters may be able to focus solely on giving their own talk or presenting their own content while an organizer performs setup, launches content blocks, etc., but still be able to see where in the schedule the presentation stands. Thus, the smart content presentation system includes methods for more efficiently producing or coordinating online events without expensive hardware, or where all parties involved are remote. In the illustrated example, all presenters may need to do is make sure their audio-visual feeds are being published to the online event. In particular embodiments, multiple presenters may be able to collaborate remotely and asynchronously to build the Storyboard and rehearse both synchronously and asynchronously for the live event.

In particular embodiments, interfaces of the smart storyboard may facilitate content blocks to be organized in any sequence through simple interactions (e.g., drag-and-drop interactions). The interface 100 includes a content organization section 110. The content organization section 110 includes interface elements for a variety of content objects 120a-120e. The content organization section 110 further includes an interface element 125 to add a new content block. Because the interface 100 shown in FIG. 1A includes components to add additional content blocks, the interface 100 may be particularly targeted for content organizers. The interface 110 also includes an interface element that provides overview information for the presentation and the progress of an active presentation 130. FIG. 1B illustrates a detailed view of the content organization section 110 of FIG. 1A. As illustrated, the content organization section 110 may also include additional interface elements to facilitate the user to view additional information associated with the current content presentation. These interface elements may relate to the actual interactive presentation of the content, and not just the design of the content presentation. For example, the interface 100 may include options for controlling the audio and video feeds used during the presentation. The interface 100 may include options for viewing the participants who will be involved in presenting the related content. As described previously, the content organization section 110 for a presenter may be similar to the content organization section 110 shown for an organizer. However, the content organization section 110 may be simplified and lack certain elements, such an interactive element 140 to start a presentation, an interactive element 125 to add additional content blocks, or an interactive element 145 to end the presentation preparation mode.

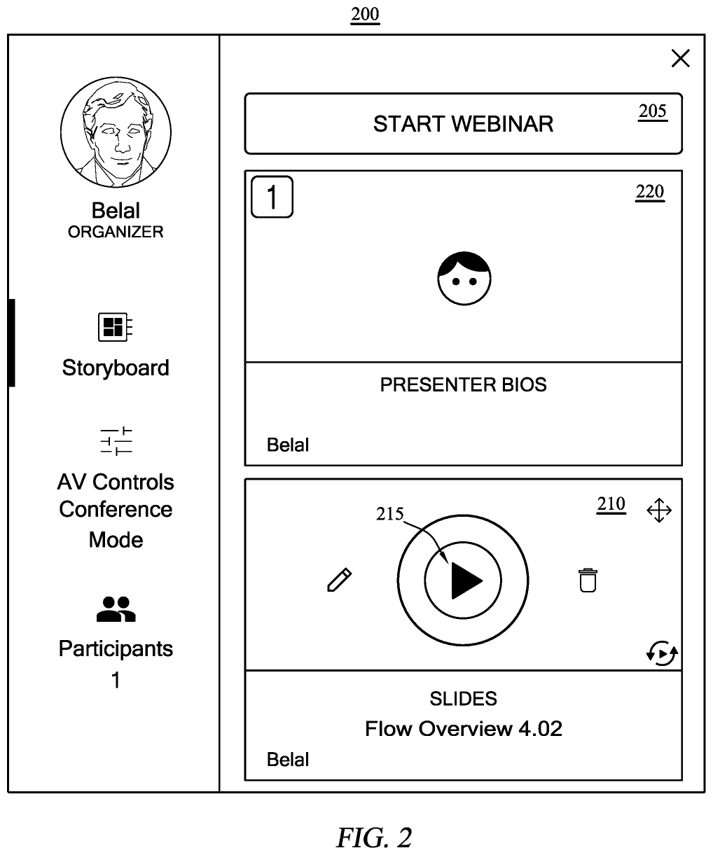

FIG. 2 illustrates an example embodiment of an interface 200 of the smart storyboard system. The interface 200 illustrated in FIG. 2 relates to an organizer launching a presentation through the smart content presentation system. Like the interface 100 illustrated in FIGS. 1A-1B, the interface 200 includes a number of elements related to different content blocks and operations related to the content blocks. For example, element 220 relates to a content block corresponding to a slideshow to be used to discuss biographies of the presenters of the presentation. Another element 210 relates to a content block containing the bulk of the slides for the presentation. An organizer may interact with the element 205 to launch the online event, e.g., to cause a stream of the online event to be broadcast to an audience of attendees. At the start time of the online event, the organizer (e.g., event host) may click the interactive element 205. During the online event, the organizer may interact with elements on the content blocks to play specific content blocks (e.g., the element 215), or, if automation is pre-selected, the online event may self-launch at the appointed time with one content block (e.g., content block corresponding to element 220) playing after another (e.g., content block corresponding to element 210).

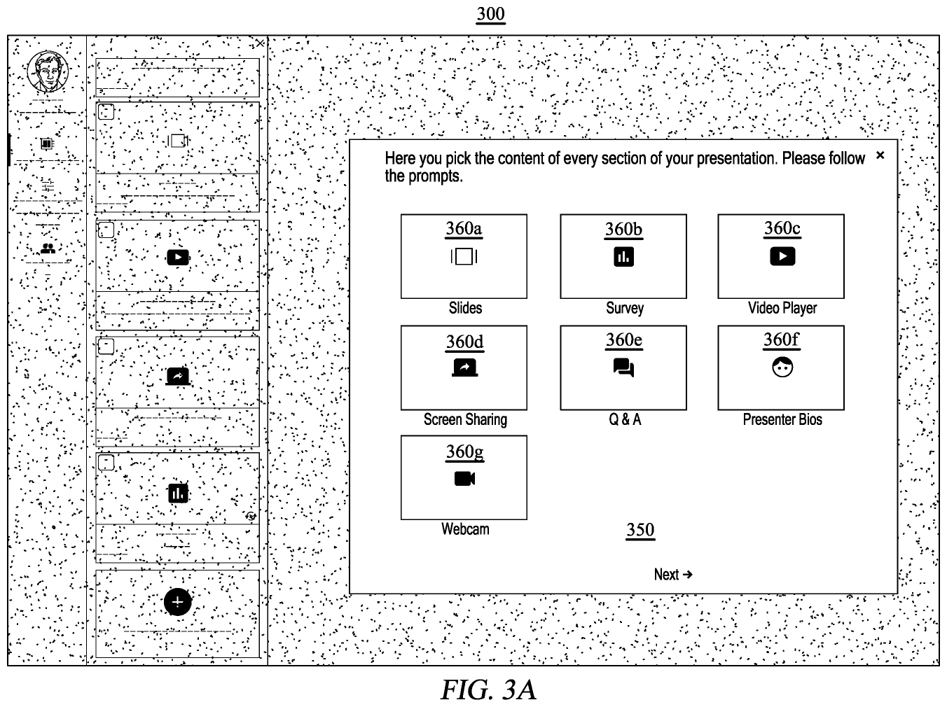

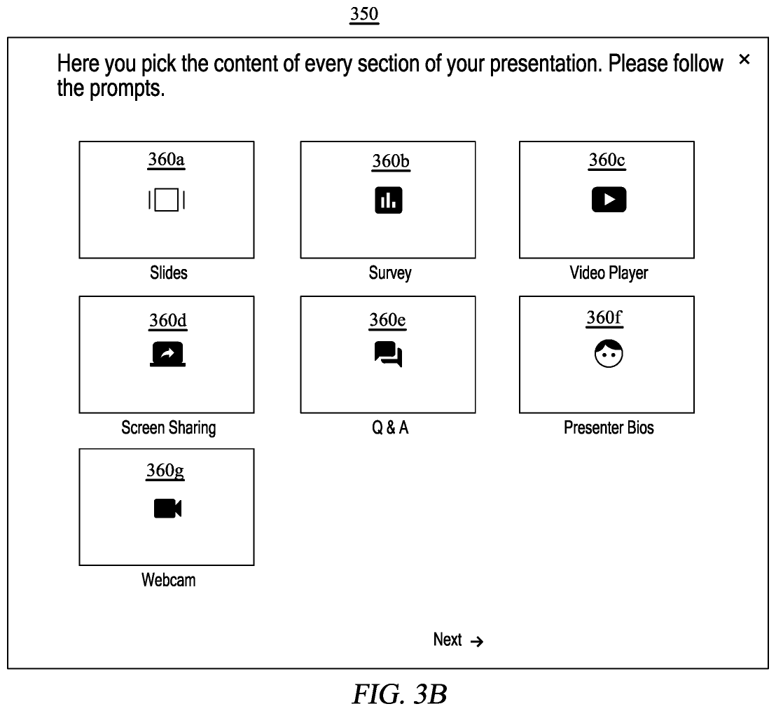

FIGS. 3A and 3B illustrate an example interface 300 for selecting content for a smart storyboard-based presentation and a detailed view of the content blocks for selection. content blocks are the building blocks of the smart storyboard. In particular embodiments, the interface 300 may be caused to be displayed on a computing device executing the smart storyboard application in response to a user interacting with element 125 of FIGS. 1A-1B. The interface 300 includes a prompt 350 for inserting additional content blocks to a presentation. The prompt 350 may include a variety of interactive elements 360a-360g corresponding to the compatible content block types for the presentation. The prompt 350 may include written instructions or directions for the user indicating how to user the interface 300. FIG. 3B shows a detailed view of the prompt 350. The example types of content blocks shown in FIGS. 3A and 3B include slides 360a, survey 360b, video 360c, screen sharing 360d, questions & answers 360e, presenter biographies, 360f and webcam 360g. Other types of content blocks not illustrated in FIGS. 3A and 3B may include, but are not limited to whiteboard, quiz/exam, competition/game, and breakout room.

A slides content block 360a may include a slideshow presenting prepared content, typically text and images or other graphics. A survey content block 360b may include a question prompt along with multiple choice or written response answer fields through which a member of the audience (e.g., an “attendee”) of the online event may respond to the question prompt. As described herein, the survey results may be collected and optionally presented by an organizer or presenter. A video player content block 360c may facilitate the presentation of a video to the audience. The video player may stream video from the content presentation system application or media server or from another third-party media server. A screen sharing content block 360d may facilitate a presenter streaming the content of one or more application windows executing on the presenter's computing device. A question and answer content block 360e may solicit questions from the audience with the ability for attendees to “like” or review submitted questions, and the organizer to prioritize responses, whether through the content block, a chat function, or other interactive format, and facilitate the presenter to provide answers to the submitted questions. A presenter biographies content block 360f may be a specially formatted content block for presenting information about one or more presenters of the online event. A webcam content block 360g may cause a webcam of the presenter or selected by the present to be displayed through the online event video and audio stream. A whiteboard content block may provide a space for the presenter or optionally audience members to produce content live during the online event, such as by drawing on the content block using an touch input or input device, by entering text or other means. A quiz/exam content block may be similar to a survey content block, but specially formatted to not reveal submitted responses. Similarly, a competition/game content block may be specially formatted to induce competition among attendees or teams of attendees. A breakout room content block may cause attendees of the online event to be split into one or more groups with different groups of attendees/presenters be directed to different, smaller online event or audio-video communication groups.

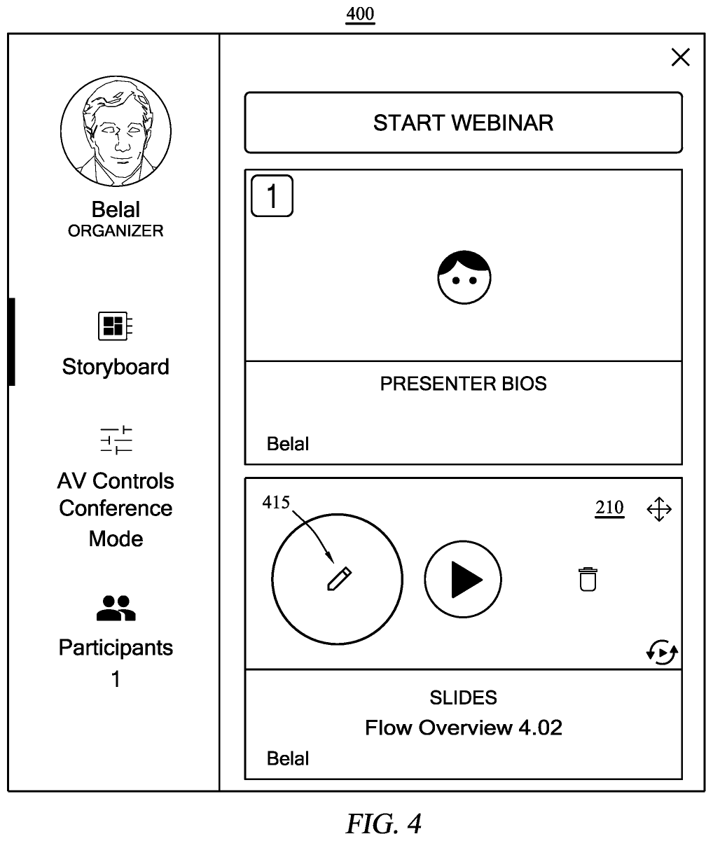

FIG. 4 illustrates an example interface 400 for facilitating editing of content blocks for inclusion in the smart storyboard. In particular, interface 400 includes an interactive element 415 on the content block 210 that may enable a separate content editing interface. In particular embodiments, content blocks may be editable up to the point of launch. For example, if an additional presenter for an online event becomes available at the last minute, his name may be added to the slides content block using the interactive element corresponding 415 to the edit icon.

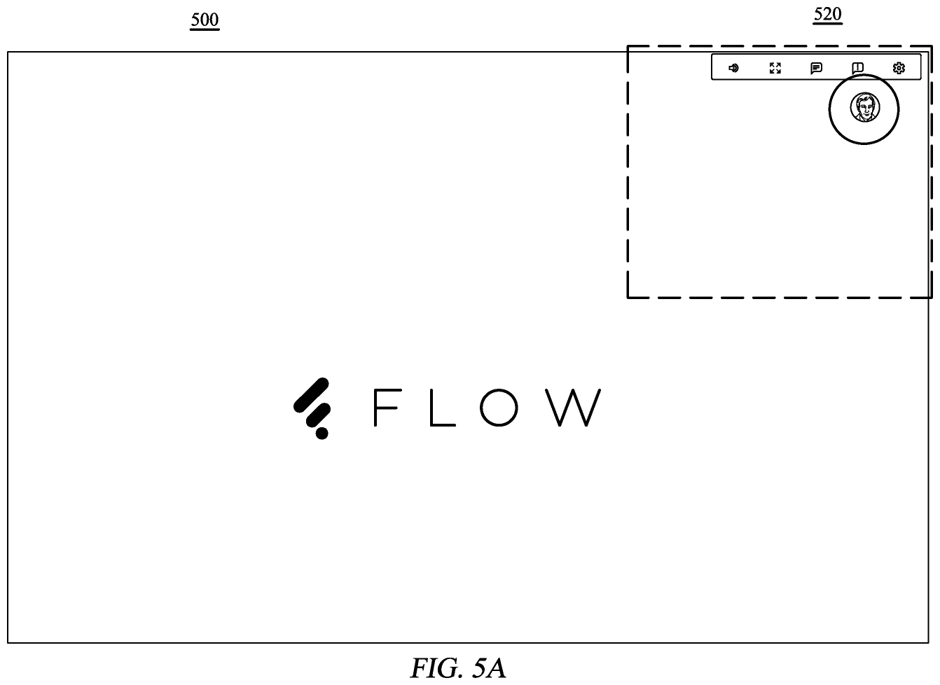

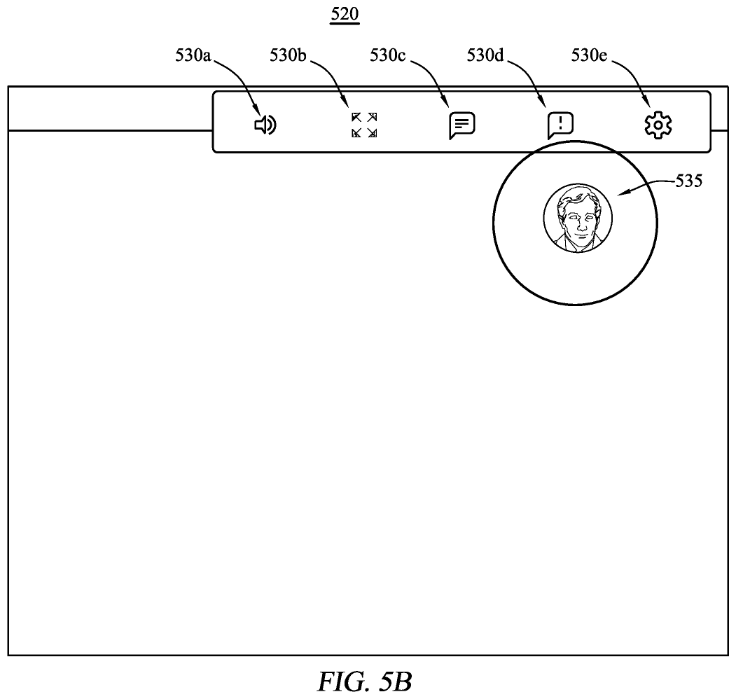

FIGS. 5A and 5B illustrate an example interface 500 shown to viewer of the online event, such as an online event attendee, where the online event is presented using a smart storyboard. As illustrated in FIG. 5A, the person viewing the online event may be shown a relatively unobstructed view of the content (e.g., content corresponding to one or more content blocks) broadcast using the smart content presentation system. FIG. 5B shows a detailed view of the indicated portion 520 of the interface 500 highlighted in FIG. 5A. As shown in FIG. 5B the interface 500 includes a set of controls for interacting with the smart content presentations system. The controls include interactive elements relating to adjusting the volume of the online event stream 530a, adjusting the presentation of the video of the online event stream 530b (e.g., maximizing the size of the content window), interacting with a chat function of the smart content presentation system 530c, having the organizer make a text announcement 530d, other detailed settings 530e, and indicating an issue with the online event or the user's experience (not illustrated). In particular embodiments, the interface 500 also includes an icon 535 indicating the broadcast status and identity of a presenter of a specific content block in an unobtrusive manner (e.g., other than including just a video stream of the presenter).

In particular embodiments, content blocks within the storyboard may control the broadcast status 535 of presenters assigned to certain content blocks or portions of content block. When a content block assigned to a presenter starts, the assigned presenter may be put “on air” so attendees will see their video and/or audio feeds. One benefit of this this important function over previous systems may allow presenters to focus on presenting their content and not worry about operating any hardware/software technology to facilitate the presentation. Additionally, attendees may benefit from presentation of a seamless online event experience with an avatar of the presenter 535 that informs them of the identity of the presenter who is talking. The clean, easy to understand interface provides an environment conducive to focusing on the content, while retaining the ability for attendees to interact through chat and questions.

The content blocks also act as a way of organizing a media library that may be uploaded by presenters and organizers via a client application executing on a computing device of the presenter or organizer. In particular embodiments, the media library may be presented and organized in a way similar to being in a familiar desktop or mobile file organization interface. Functions common to those organization interfaces may also be present, including, but not limited to sorting files (e.g., file type, file name, file size, date added, date modified), previewing files, modifying files, etc. A query between the client application and an application server for the smart storyboards may determine which library to use based on the content type. The media library may facilitate presenters or organizers efficiently using the media during a presentation. The platform is versatile enough to support use in dramatically varied use cases. As an example only and not by way of limitation, a firm can have face-to-face meetings with clients, show them videos and sales documents, instruct the client download the documents, sign them, and upload them through the online event. Therefore, the platform facilitates creating a complete sales or related channel.

Content block objects may be designed in an object-oriented manner that allows each content block to have independent behavior based on actions taken involving the content block object, such as different behaviors on launch, or while on- or off-stage. Object-oriented content block objects have the benefits over prior systems because this paradigm allows development of new features for content block behavior by inheriting general content block behavior, then building more specific actions on top of each type. As an example and not by way of limitation, a normal content block may be configured to always put assigned presenters on air, but a slides content block with associated announcement configurations may also push out an announcement for the new presenter.

Every content block may have generic property types common to all content blocks, such as timers, identifiers (ID), assigned presenters, etc. Content blocks may have more detailed properties depending on the content block type. Content block interactivity may similarly operate and respond in a parent-child, dependent manner. Action calls from the client application may be routed through generic or standard content block behaviors, before going through the specific interaction path for how an individual content block should respond. For example, if a content block or presentation reset is called for, the standard content block behavior may reset associated timers to 0. A media-type content block may also make the call to a media server to stop publishing media streams related to the content block. Inherited content block interactivity and behavior, as described herein, greatly simplifies the procedures and interactions required to build a highly complex and interactive presentation. Furthermore, presentations may be optimized to efficiently use computing and network resources according to inherited content block types.

In particular embodiments, the smart storyboard application server may employ certain efficiencies to manage demand on the application server, media server, and other related content providers. For example, media playing content blocks may be created on demand when launched to reduce the overall number of shared objects managed by the application. Control and player modules of the smart storyboard may have a protocol of communication between each other so the control module will only take status change actions when the player modules are ready to respond. In combination, this results in a more efficient management of the resources of the application server and related content providers.

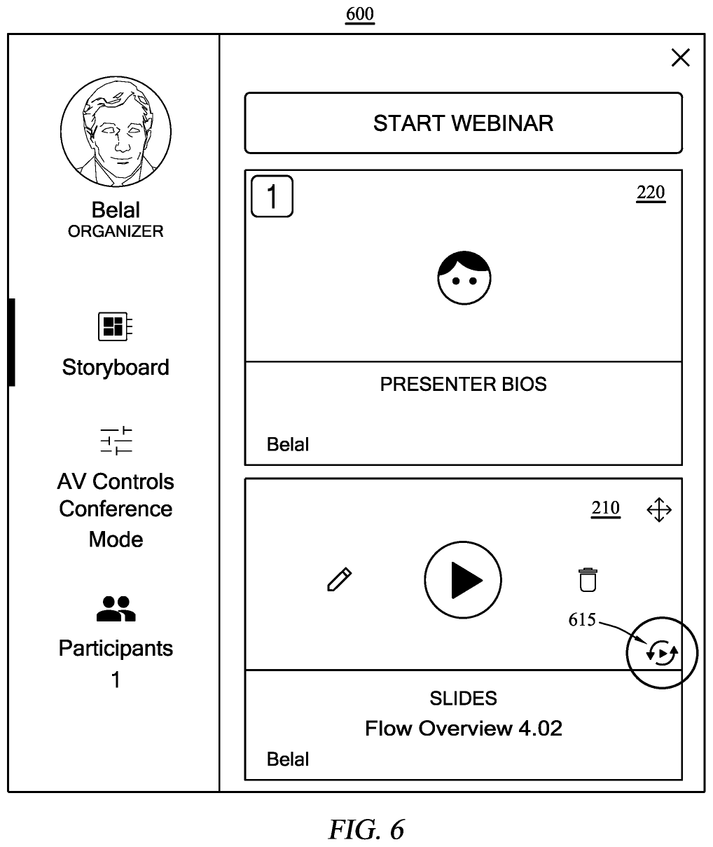

In particular embodiments, content blocks may be configured for parts of the overall presentation of an online event to be pre-recorded while preserving interactivity during responsive portions of the online event using responsive content block types, such as surveys. For the purposes of illustration, this functionality may be referred to as AutoFlow. Using AutoFlow, the smart storyboard presentation may capture audio and video feeds from presenters. AutoFlow may also enable the smart storyboard application to execute further control over the presentation of the online event, such as slide changes or interactions with a laser pointer tool used by a presenter to highlight certain portions of a content block while they are presenting. FIG. 6 illustrates an interface 600 for the content presentation system including an interactive element 210 for an AutoFlow-enabled content block and an interactive element 220 for a non-AutoFlow content block. As shown in FIG. 6, a content block 210 in the storyboard interface 600 that has AutoFlow enabled may display a corresponding icon or interactive element 615 to indicate to an organizer that AutoFlow will control presentation of the particular content block 210. AutoFlow may also respect the order of the storyboard, allowing content to chain sequentially from one to another. In particular embodiments, AutoFlow recordings may be related to a specific media type. Thus, in development, pre-recorded AutoFlow selection may involve narrowing down by media type, specific content, then AutoFlow recording using the media library interfaces discussed herein.

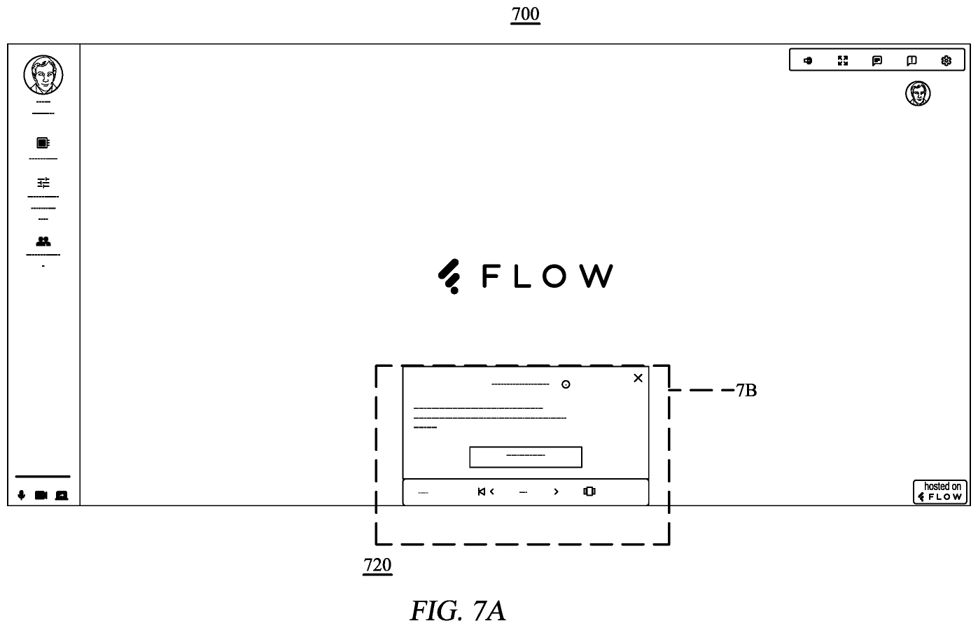

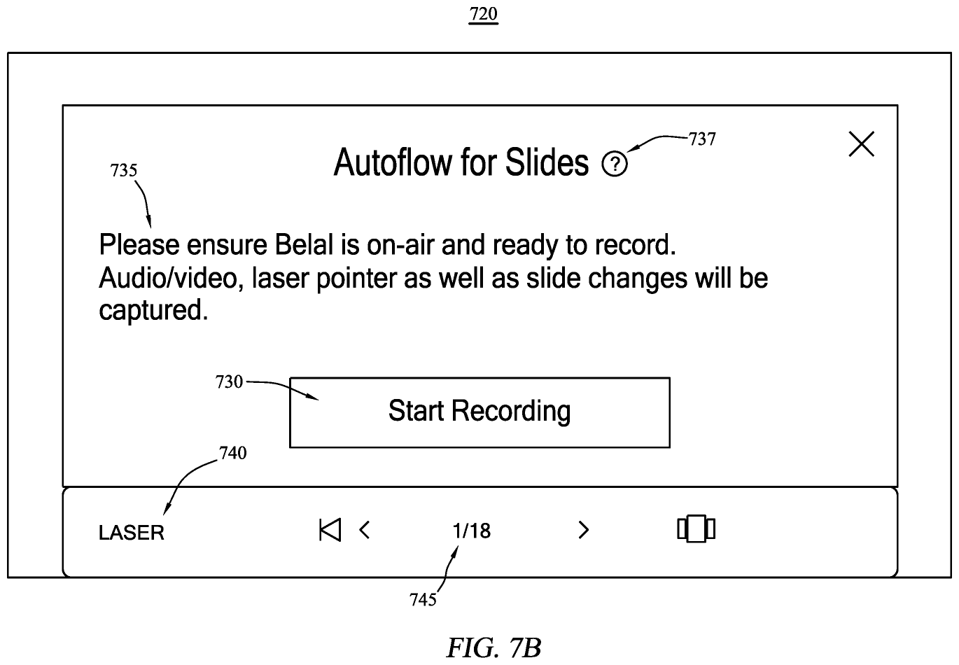

FIGS. 7A and 7B illustrate an example interface 700 for recording an AutoFlow presentation. As shown in FIG. 7A, the interface 700 includes, in addition to other interface elements discussed herein, a prompt 720 informing the presenter or organizer that the smart content presentation system is ready to begin recording an AutoFlow content block. FIG. 7B illustrates a detailed view of the prompt 720. The prompt 720 includes a title and explanatory text 735 reminding the presenter or organizer that an AutoFlow recording will ensue. The prompt also includes an interactive element 737 for the user to gather additional information. The prompt also includes an interactive element 730 that the presenter may interact with to begin the recording of the AutoFlow segment. While the presenter is presenting the content block, they may interact with the prompt to perform functions such as engaging a laser pointer function by interacting with the interactive element 740 or to change the slides (or otherwise advance the content block) through interacting with the interactive element 745.

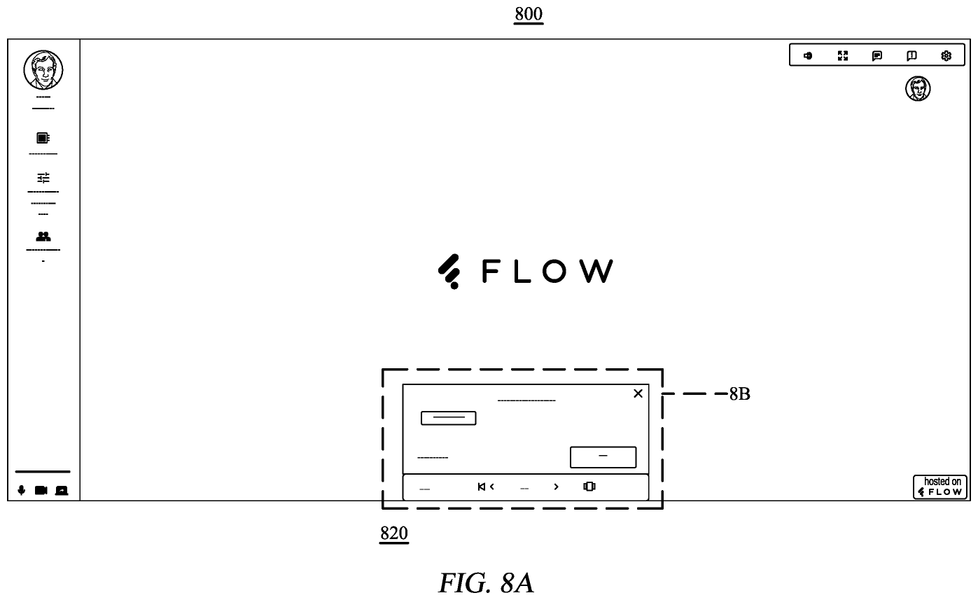

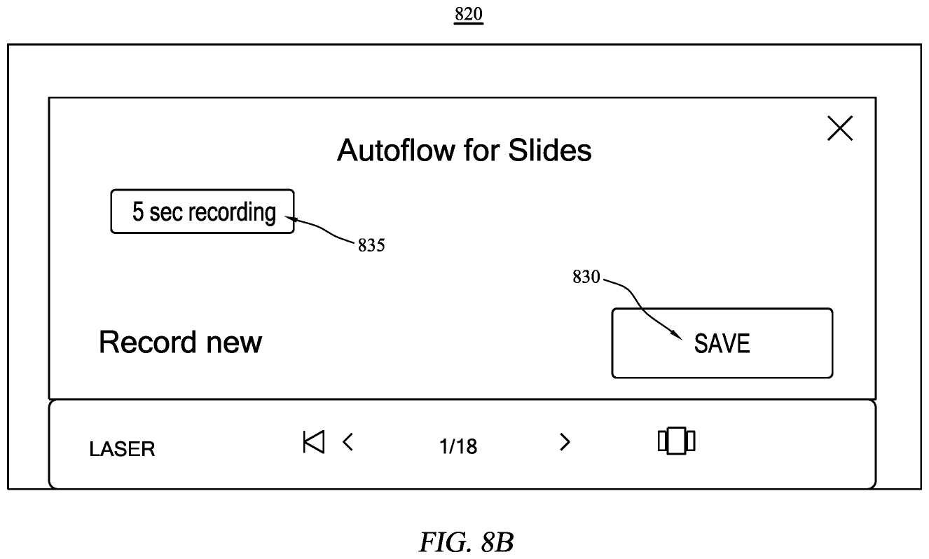

FIGS. 8A and 8B illustrate an example interface 800 shown after a presenter has recorded an AutoFlow presentation. As shown in FIG. 8A, the interface 800 includes, in addition to other interface elements discussed herein, a prompt 820 informing the presenter or organizer that the smart content presentation system has successfully recorded the AutoFlow presentation. FIG. 8B illustrates a detailed view of the prompt 820. The prompt 820 includes information 835 summarizing the recording, such as the length of the recording, and an interactive element 830 through which the presenter or organizer may save the recording of the AutoFlow presentation for later use. The presenter may re-record their presentation as many times as they need until they are happy with the result.

Each content block may be assigned and maintain its own state within the online event presentation that stores information such as the current status of the content block, the assigned presenters, and miscellaneous information relevant to the type of the content block. As an example, state information for a survey-type content block may retain the responses to surveys presented during the content block. In particular embodiments, the states may be stored with a shared object mechanism discussed herein.

In particular embodiments, smart storyboard states may be managed in two parts: the control module and the player module. Each module type may have its own notifier group which represents which users will see what changes. These notifier states may change when an online event goes live. In general, control modules may be available only to the operators and store more back-end related states. Player modules may be available to operators and once the online event is live, to attendees as well, storing information that is relevant to what's being displayed on the screen.

Content blocks may be loaded from and saved to a database, enabling them to persist across sessions. Their associated content may be managed through an interface, allowing organizers to select previously uploaded media objects. As an example use case for persistent content block consider a sales demonstration using screen share. The actual screen share portion of the demonstration can be presented and recorded by one person. During the same online event, the introductory portions of the presentation and questions before or after the demonstration can be handled live by another presenter. In another example use case, a customer may be using a store's website to make an online purchase but may have questions regarding a specific product or feature of the site. The user can request assistance by interacting with a live customer service representative or an automated system. In response to the user's request, a predetermined content block can be launched that responds to the user's question by, for example, showing more details on the product or how the feature works. If the user still has questions, a customer service agent can then be permitted to share their screen or call the user through an appropriate content block to handle their questions. As another example use case, consider a teacher who has prerecorded portions of a lecture using first content block. The teacher can also integrate content blocks such as survey questions to assess students' understanding of the material as they view the prerecorded portions of the lecture. The survey results can persist across different presentations of the online event. Additionally, the teacher can include a portion of the online event allowing for live question and answering (e.g., reserving 15 minutes where the teach interacts with students with questions who have interacted with the survey). Persistent content blocks allow for more efficient use of produced content blocks and can simulate live presentations, even when the ordinary presenter is not available. For example, a sales manager may record a welcome video by the chief executive of a company to launch an online event with an AutoFlow webcam block and transition the online event to a live webcam block the sales manager to deliver further content, expanding on the executives remarks. As another example, a user may use the content blocks to enhance the appearance of streaming live content, such as a live video blog or video game demonstration. The user can switch between a live webcam content block or video input content block and prerecorded content block (such as advertisements or frequently asked questions). The user can also use a survey content block to solicit feedback and advice.

The smart storyboard system may support recording, storing, and presenting detailed analytics for presenters and organizers. The smart storyboard may support attendee analytics such as attendee log in and log out time, log in and log out location. Additionally, the smart storyboard system may support customizable attendee engagement metrics. In particular embodiments, organizers may choose what aspects of engagement is important to their use cases and create metrics, e.g., using a sliding scale, for that particular audience and then measure the custom metrics.

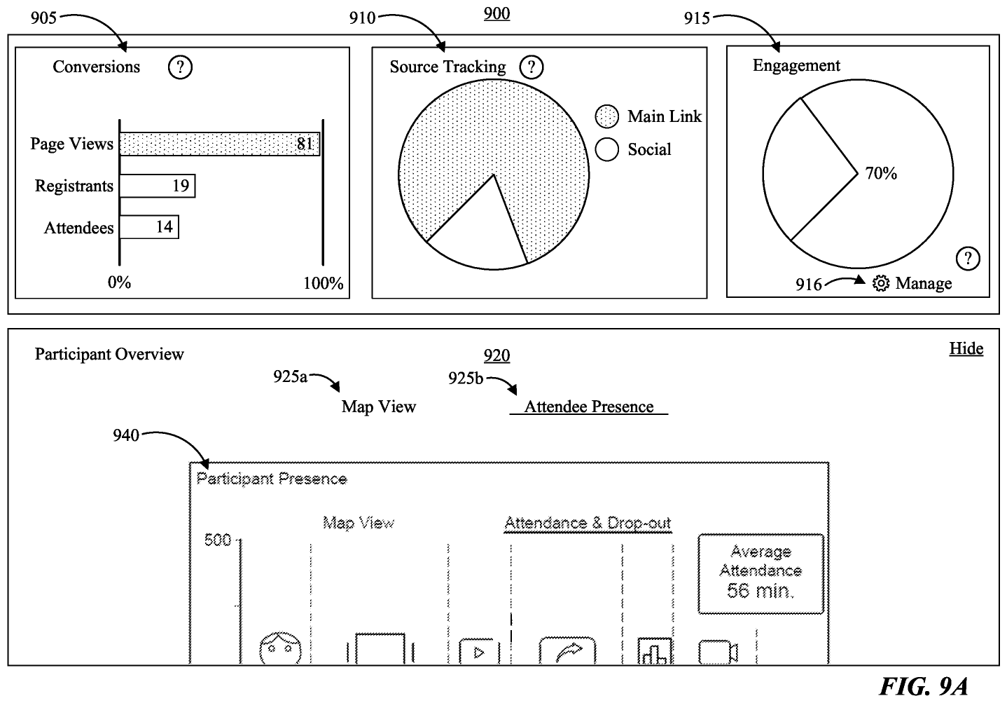

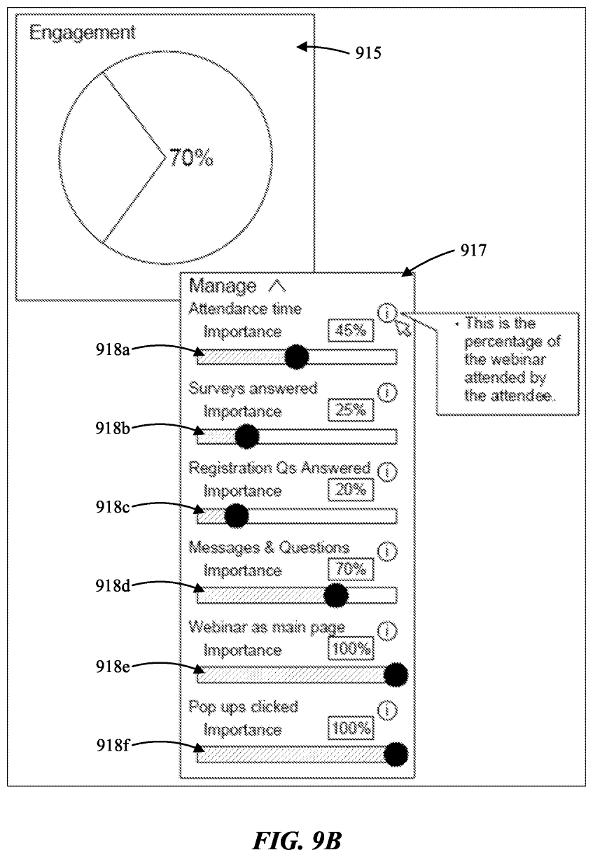

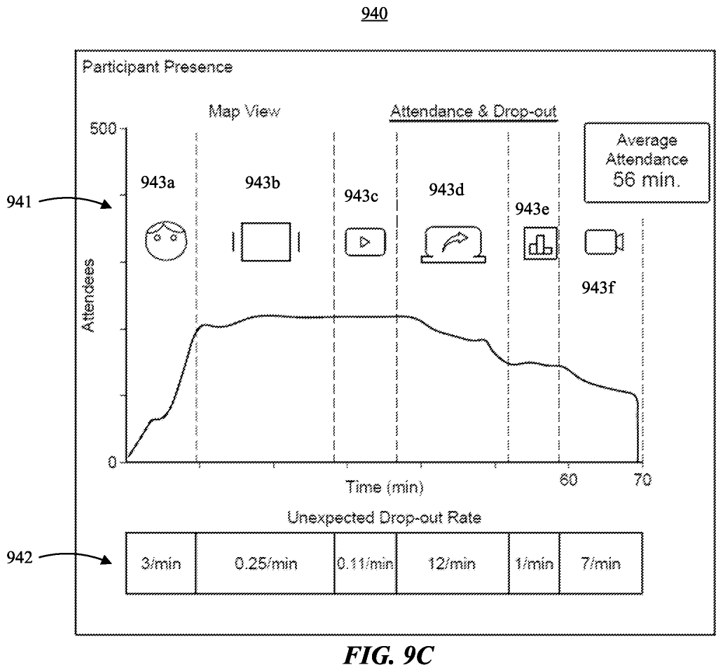

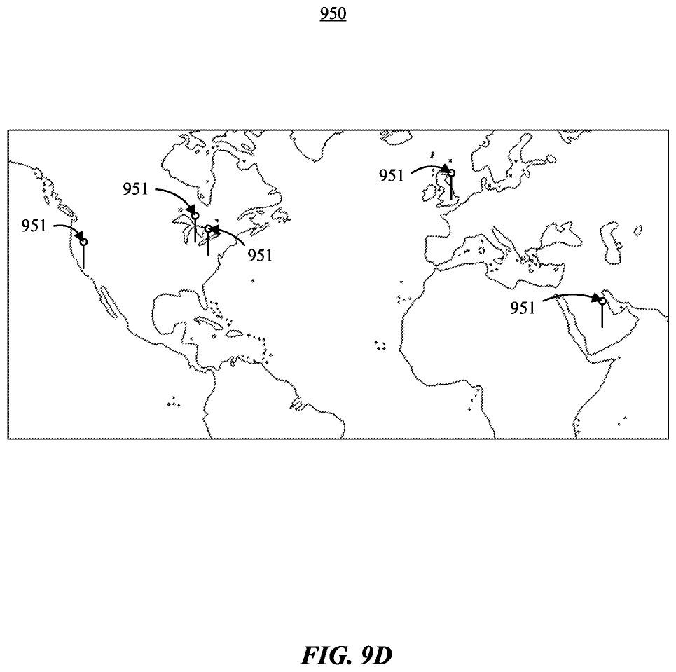

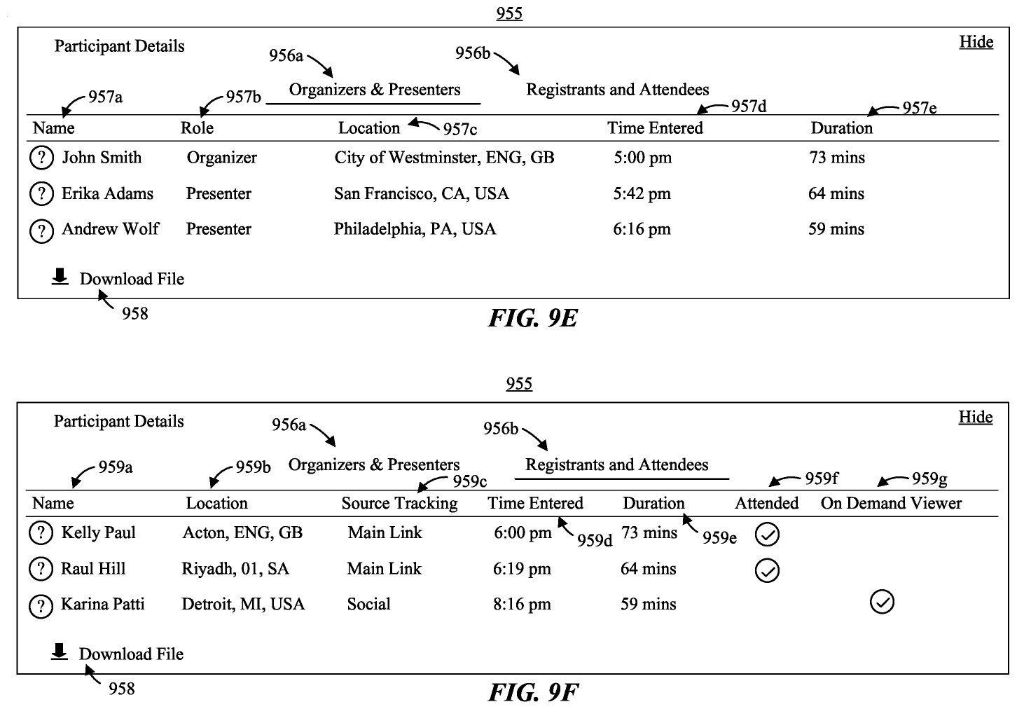

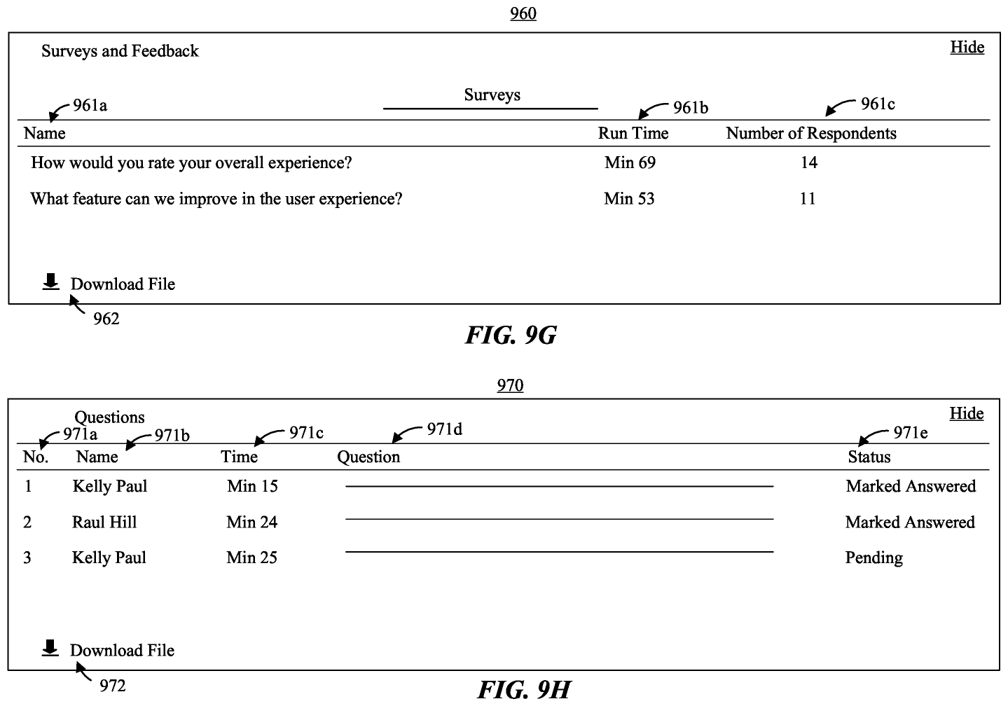

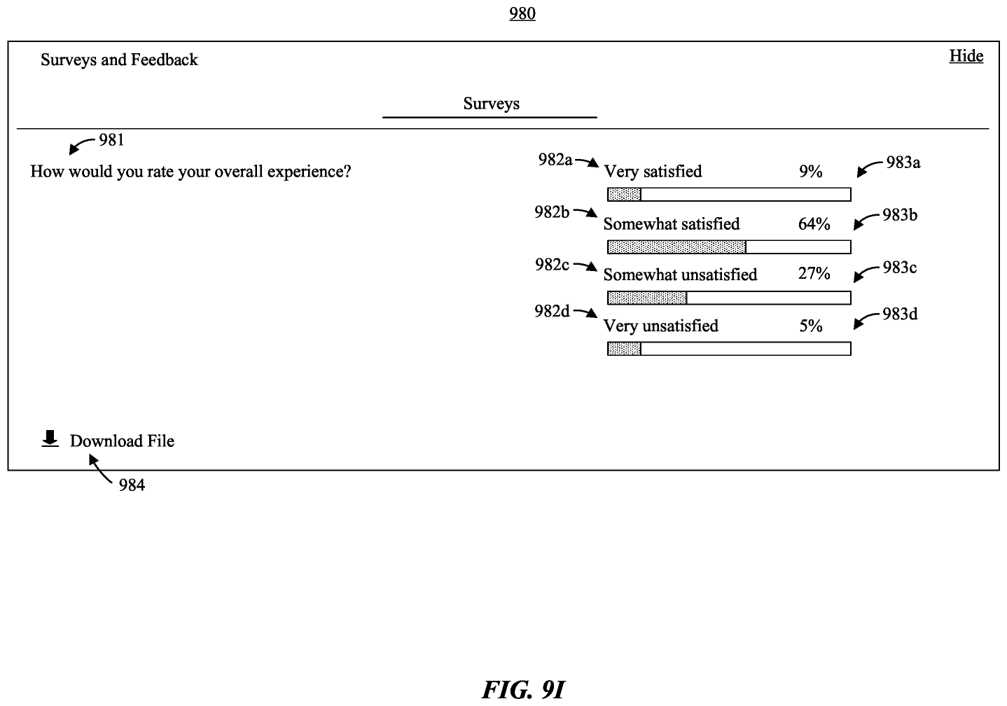

FIGS. 9A-9I illustrate example embodiments of example interfaces for reviewing the reach an impact of an online event presentation. FIG. 9A illustrates a first interface 900 that may be accessed up requesting to view metrics about the attendees, interactions, and reach of an online event. As an example, the interface 900 includes a conversion component 905 that illustrates metrics regarding the attendance figures for the online event. These conversion metrics can include, by way of example only, the number of page views for the online event, the number of users who viewed the registration page, the number of registrants, the number of attendees, the percentage of attendees who registered in advances, the percentage of registrants who attended, and other similar metrics. As another example, the interface 900 includes a source tracking component 910, which can be used to identify the source of event registrations. As an example, the source of the registration can refer to the particular link or type of link used by users to reach the registration page. The illustrated source tracking component 910 shows that a significant number of registrants arrive through the main link used by the online event, while some reached the registration page through links used on social media. The designation of the source names can be customizable. The source tracking component 910 can also, for example, be used to track the source page from which event attendees arrived at the online event. As another example, the interface 900 includes an engagement component 915. As described herein, the engagement component 930 can include a customizable engagement score used to rate the success of the online event presentation. The interface 900 can also include a participant overview component 920 that shows, as described herein, summary information describing the attendees of an event as well as when and how they interacted with the online event presentation. The participant overview component 920 can include interactive elements to select between various views. In the illustrated interface 900, the user can use a first interactive element 925a to select a map view interface 950 or a second interactive element 925b to select an attendee presence interface 940

FIG. 9B illustrates a detailed view of the engagement component 915, and further illustrates an example of customizing the calculation of the engagement score. As illustrated, the interface includes an element 916 that can, for example, cause an interactive section 917 to pop-out that includes interactive elements 918a-918f through which a user may adjust the importance of each metric in an overall engagement rating for a presentation. The section 930 also includes a name and hover-over interactive element providing an explanation of the individual metric and its impact on the overall engagement score. The weighting selected by the user for each metric may be combined with the values collected by the smart content presentation system during an online event presentation to provide an engagement rating for the online event. In the example embodiment illustrated in FIG. 9B, various engagement variables may be chosen such as:
L (918a): attendance duration as a percentage of maximum attendance length of any attendee
P (918b): percentage of survey questions answered
R (918c): percentage of optional questions answered
Q (918d): number of times attendee initiated a chat message as a percentage of highest attendee chats
A (918e): length of time online event was front tab as percentage of attendance duration
C (918f): percentage of pop-ups clicked within allocated time

FIG. 9C illustrates an example detailed view of an attendee presence interface 940 for reviewing engagement metrics collected during an online event presentation. In the example embodiment illustrated in FIG. 9C, participant presence is shown on a per content block-basis. The attendee presence interface 940 shows a graph 941 of the number of attendees of the online event compared to the runtime of the online event. The graph is divided into a number of segments 943a-943f, with each segment showing the type of content block being presented during that segment. The attended presence interface 940 also includes section 942 that displays a calculation of the rate of unexpected drop-outs from the presentation, which corresponds to the number of attendees who left the online event at an unexpected portion of the online event. On review of the attendee presence interface 940 a user can determine, for example, which content block types are most effective at retaining the attention of attendees. The smart content presentations system may further support additional analytics presentation interfaces as deemed useful to review the collected analytics (e.g., a graph showing engagement over time for an online event, certain presenters over a course of online events, types of content blocks, etc.).

FIG. 9D illustrates an example detailed view of a map view interface 950. The map view interface can be used to show the locations, marked by pins 951, of the individuals associated with the online event. As an example, the map view can be customized to show the locations of organizers, presenters, attendees, and other users. The map view interface 950 can be interactive to allow the user to zoom in on selected locations (e.g., where multiple pins are place close to one another, the user can zoom in to see greater detail). The map view interface 950 can also automatically select a zoom level to focus in on the areas associated with actual user locations.

The interface 900 can be configured to be modular and can show many types of detailed views. These views can include the components illustrated in FIG. 9A. In addition, this disclosure contemplates additional views that can be made available by user selection or by recommendation. FIG. 9E illustrates an example detailed view of a participant details component 955. The participant details component 955 can be used to see detailed information associated with various participants in the online event. In the example illustrated in FIG. 9E, the participant details component 955 includes one or more interactive elements 956a and 956b to select between a view illustrated detailed information about organizers and presenters of the online event presentation and the registrants and attendees of the online event presentation respectively. The participant details component 955 further includes an interactive element 958 to download the information stored by the system with respect to the participants in the online event presentation. The information can be made accessible in a various of formats suitable for processing spreadsheet data. The participant details component can include, for example a table including rows for each participant along with information about the participant that has been gathered by the system (e.g., during their account registration or registration for the event). The columns of the table can include, for example, a column 957a for the participant's name, a column 957b for the participant's role, a column 957c for the participant's given or detected location, a column 957d for the time at which the participant first entered the online event, or a column 957e for the duration of the participant's participation in the online event. FIG. 9F illustrates an additional detailed view of the participant details component 955, where the user has interacted with the interactive element 956b to view details on the registrants and attendees of the online event presentation. The participant details component can include, for example a table including rows for each participant along with information about the participant that has been gathered by the system (e.g., during their account registration or registration for the event). The columns of the table can include, for example, a column 959a for the participant's name, a column 959b for the participant's given or detected location, a column 959c for the source of the participant's registration or attendance of the online event, a column 959d for the time at which the participant first entered the online event, a column 959e for the duration of the participant's participation in the online event, a column 959f for whether the participant attended the online event live, or a column 959g for whether the participant attended the event as a viewer of a video on demand.

FIG. 9G illustrates an example detailed view of a surveys review component 960 that can be included in the interface 900. The surveys review component 960 may be one of many components of a surveys and feedback component that can be used to house information about surveys, survey responses, questions submitted by live or on-demand participants, or a record of chat messages submitted during the online event, or other similar information. The surveys review component can include an interactive element to download the data associated with the online event corresponding to survey information. The surveys review component may include a table of information corresponding to the survey-type content block included in the online event presentation. The table can include, for example, a column 961a for the name or question associated with the survey, a column 961b for the time during the online event presentation when the survey content block was presented, or a column 961c for the number of respondents who have submitted a response to the survey. The surveys review component 960 can further include an interactive element 962 to download the survey information.

FIG. 9H illustrates an example detailed view of a question review component 970 that can be included in the interface 900. The question review component 970 can include an interactive element 972 to download the data associated with the online event corresponding to the question information. The question review component 970 can include a table with information about questions submitted by the participants during the online event presentation (e.g., submitted through the online event interface or as a question-type content block). The table can include, for example, a column 971a for a number or identifier for the question, a column 971b for the name of the participant that submitted the question, a column 971c for the time in online event when the question was submitted, a column 971d including the text of the question, or a column 971e indicating the answered status of the question, for example whether the question has been marked answered by the question asker or another participant, or whether the question is still pending. The surveys review component 970 can further include an interactive element 972 to download the question information. In addition to the question review component the system can provide an interface to view or download some or all of the chat messages sent between attendees and participants in the online event presentation.

FIG. 9I illustrates an example detailed view of a survey results component 980 that can be included in the interface 900. Additionally or alternatively, the survey results component 980 can be presented after interaction by the user with an interactive element in, for example, the surveys review component 960. For example, the user can interact with a name element (e.g., in column 961a) for a particular survey (e.g., the survey named “How would you rate your overall experience?” illustrated in FIG. 9G) and the system can cause the survey results component 980 corresponding to that survey question to be displayed, as illustrated in FIG. 9I. The survey results component 980 can include the text of the survey question 981, for example “How would you rate your overall experience?”. The survey results component 980 can include the text of each of the survey responses offered, for example “Very satisfied” 982a, “Somewhat satisfied” 982b, “Somewhat unsatisfied” 982c, and “Very unsatisfied” 982d. The survey results component 980 can include a visible or textual representation 983a, 983b, 983c, or 983d, of the number or percentage of respondents who selected each option. For example, element 983a indicates 9% of respondents selected “Very satisfied” while element 983c indicates 27% of respondents selected “Somewhat unsatisfied”. The survey results component 980 can further include an interactive element 984 to download the details results for this survey.

In particular embodiments, the smart storyboard system supports a novel object type referred to as a shared object. Shared objects provide a method to store and share content block sub-states within the application server. The session state of an online event as a whole may be conceptualized as managed through the use of multiple instances of different shared objects.

In particular embodiments, the shared object state works as a hash map and may include additional functions to manage and broadcast the state of the shared object. Helper functions for the shared object may be set to integrate with databases maintained by the smart storyboard application to share states within multiple processes of the smart storyboard application server. The shared object may enable advanced usage of various functions of the smart storyboard application including a users list (which may indicate the organizer, presenters, or attendees associated with presentation or content block), content block states, and a chat function associated with each content block or online event.

Each shared object may include a notifier mechanism and a locking mechanism in addition to its data. The notifier mechanism may hold socket information corresponding to system users (e.g., organizers or presenters) that receive data change updates. For example, a shared object may include an operator notifier that is associated with all organizers and presenters of a content block as well as a general notifier that is associated with operators as well as all attendees and recorders. Shared objects may be updated by manager class instances that create them.

In particular embodiments, a shared object may send its complete state on initial connection to an application server. Updates to the state information may include instruction sets that instruct clients how to modify the represented states accordingly. Updates to the data may in turn cause the notifier associated with the shared object to broadcast the instruction sets.

A shared object lock mechanism allows for a batch of updates to be processed before a notifier is called. Using the lock mechanism, one socket call may receive and handle multiple instruction sets.

In particular embodiments, the data element of the shared object may use a proprietary cached dictionary mechanism. The cached dictionary mechanism that integrates with a data structure store using appropriate set/get methods, which have a local in-memory object. The cached dictionary also supports mirroring to the data structure store if such a feature is enabled by the application server and data structure store.

Particular embodiments may repeat one or more steps of the example process(es), where appropriate. Although this disclosure describes and illustrates particular steps of the example process(es) as occurring in a particular order, this disclosure contemplates any suitable steps of the example process(es) occurring in any suitable order. Moreover, although this disclosure describes and illustrates an example process, this disclosure contemplates any suitable process including any suitable steps, which may include all, some, or none of the steps of the example process(es), where appropriate. Furthermore, although this disclosure describes and illustrates particular components, devices, or systems carrying out particular steps of the example process(es), this disclosure contemplates any suitable combination of any suitable components, devices, or systems carrying out any suitable steps of the example process(es).

In all example embodiments described herein, appropriate options, features, and system components may be provided to enable collection, storing, transmission, information security measures (e.g., encryption, authentication/authorization mechanisms), anonymization, pseudonymization, isolation, and aggregation of information in compliance with applicable laws, regulations, and rules. In all example embodiments described herein, appropriate options, features, and system components may be provided to enable protection of privacy for a specific individual, including by way of example and not limitation, generating a report regarding what personal information is being or has been collected and how it is being or will be used, enabling deletion or erasure of any personal information collected, and/or enabling control over the purpose for which any personal information collected is used.

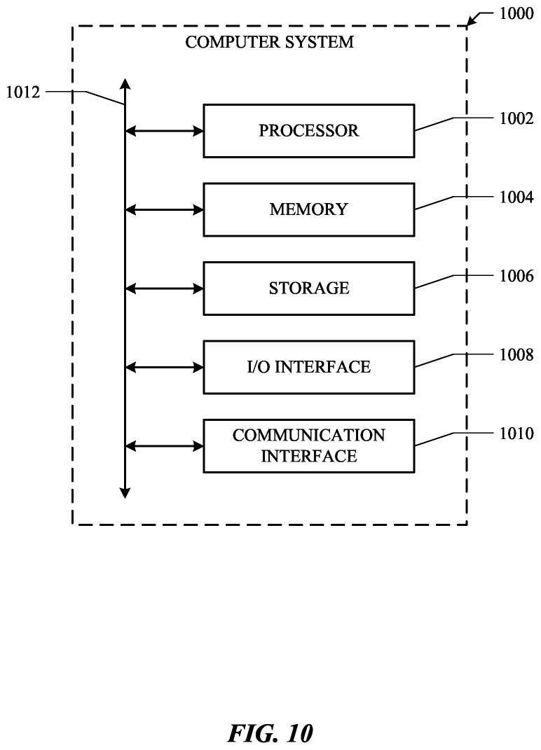

FIG. 10 illustrates an example computer system 1000. In particular embodiments, one or more computer systems 1000 perform one or more steps of one or more methods described or illustrated herein. In particular embodiments, one or more computer systems 1000 provide functionality described or illustrated herein. In particular embodiments, software running on one or more computer systems 1000 performs one or more steps of one or more methods described or illustrated herein or provides functionality described or illustrated herein. Particular embodiments include one or more portions of one or more computer systems 1000. Herein, reference to a computer system may encompass a computing device, and vice versa, where appropriate. Moreover, reference to a computer system may encompass one or more computer systems, where appropriate.

This disclosure contemplates any suitable number of computer systems 1000. This disclosure contemplates computer system 1000 taking any suitable physical form. As example and not by way of limitation, computer system 1000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1000 may include one or more computer systems 1000; be unitary or distributed; span multiple locations; span multiple machines; span multiple data centers; or reside in a cloud, which may include one or more cloud components in one or more networks. Where appropriate, one or more computer systems 1000 may perform without substantial spatial or temporal limitation one or more steps of one or more methods described or illustrated herein. As an example and not by way of limitation, one or more computer systems 1000 may perform in real time or in batch mode one or more steps of one or more methods described or illustrated herein. One or more computer systems 1000 may perform at different times or at different locations one or more steps of one or more methods described or illustrated herein, where appropriate.

In particular embodiments, computer system 1000 includes a processor 1002, memory 1004, storage 1006, an input/output (I/O) interface 1008, a communication interface 1010, and a bus 1012. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage 1006; decode and execute them; and then write one or more results to an internal register, an internal cache, memory 1004, or storage 1006. In particular embodiments, processor 1002 may include one or more internal caches for data, instructions, or addresses. This disclosure contemplates processor 1002 including any suitable number of any suitable internal caches, where appropriate. As an example and not by way of limitation, processor 1002 may include one or more instruction caches, one or more data caches, and one or more translation lookaside buffers (TLBs). Instructions in the instruction caches may be copies of instructions in memory 1004 or storage 1006, and the instruction caches may speed up retrieval of those instructions by processor 1002. Data in the data caches may be copies of data in memory 1004 or storage 1006 for instructions executing at processor 1002 to operate on; the results of previous instructions executed at processor 1002 for access by subsequent instructions executing at processor 1002 or for writing to memory 1004 or storage 1006; or other suitable data. The data caches may speed up read or write operations by processor 1002. The TLBs may speed up virtual-address translation for processor 1002. In particular embodiments, processor 1002 may include one or more internal registers for data, instructions, or addresses. This disclosure contemplates processor 1002 including any suitable number of any suitable internal registers, where appropriate. Where appropriate, processor 1002 may include one or more arithmetic logic units (ALUs); be a multi-core processor; or include one or more processors 1002. Although this disclosure describes and illustrates a particular processor, this disclosure contemplates any suitable processor.

In particular embodiments, memory 1004 includes main memory for storing instructions for processor 1002 to execute or data for processor 1002 to operate on. As an example and not by way of limitation, computer system 1000 may load instructions from storage 1006 or another source (such as, for example, another computer system 1000) to memory 1004. Processor 1002 may then load the instructions from memory 1004 to an internal register or internal cache. To execute the instructions, processor 1002 may retrieve the instructions from the internal register or internal cache and decode them. During or after execution of the instructions, processor 1002 may write one or more results (which may be intermediate or final results) to the internal register or internal cache. Processor 1002 may then write one or more of those results to memory 1004. In particular embodiments, processor 1002 executes only instructions in one or more internal registers or internal caches or in memory 1004 (as opposed to storage 1006 or elsewhere) and operates only on data in one or more internal registers or internal caches or in memory 1004 (as opposed to storage 1006 or elsewhere). One or more memory buses (which may each include an address bus and a data bus) may couple processor 1002 to memory 1004. Bus 1012 may include one or more memory buses, as described below. In particular embodiments, one or more memory management units (MMUs) reside between processor 1002 and memory 1004 and facilitate accesses to memory 1004 requested by processor 1002. In particular embodiments, memory 1004 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1004 may include one or more memories 1004, where appropriate. Although this disclosure describes and illustrates particular memory, this disclosure contemplates any suitable memory.

In particular embodiments, storage 1006 includes mass storage for data or instructions. As an example and not by way of limitation, storage 1006 may include a hard disk drive (HDD), a floppy disk drive, flash memory, an optical disc, a magneto-optical disc, magnetic tape, or a Universal Serial Bus (USB) drive or a combination of two or more of these. Storage 1006 may include removable or non-removable (or fixed) media, where appropriate. Storage 1006 may be internal or external to computer system 1000, where appropriate. In particular embodiments, storage 1006 is non-volatile, solid-state memory. In particular embodiments, storage 1006 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1006 taking any suitable physical form. Storage 1006 may include one or more storage control units facilitating communication between processor 1002 and storage 1006, where appropriate. Where appropriate, storage 1006 may include one or more storages 1006. Although this disclosure describes and illustrates particular storage, this disclosure contemplates any suitable storage.

In particular embodiments, I/O interface 1008 includes hardware, software, or both, providing one or more interfaces for communication between computer system 1000 and one or more I/O devices. Computer system 1000 may include one or more of these I/O devices, where appropriate. One or more of these I/O devices may enable communication between a person and computer system 1000. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1008 for them. Where appropriate, I/O interface 1008 may include one or more device or software drivers enabling processor 1002 to drive one or more of these I/O devices. I/O interface 1008 may include one or more I/O interfaces 1008, where appropriate. Although this disclosure describes and illustrates a particular I/O interface, this disclosure contemplates any suitable I/O interface.

In particular embodiments, communication interface 1010 includes hardware, software, or both providing one or more interfaces for communication (such as, for example, packet-based communication) between computer system 1000 and one or more other computer systems 1000 or one or more networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1010 for it. As an example and not by way of limitation, computer system 1000 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1000 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1000 may include any suitable communication interface 1010 for any of these networks, where appropriate. Communication interface 1010 may include one or more communication interfaces 1010, where appropriate. Although this disclosure describes and illustrates a particular communication interface, this disclosure contemplates any suitable communication interface.

In particular embodiments, bus 1012 includes hardware, software, or both coupling components of computer system 1000 to each other. As an example and not by way of limitation, bus 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1012 may include one or more buses 1012, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, any reference herein to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing devices:
displaying, in a user interface of one of the one or more computing devices, a plurality of content block objects comprising an online event and an interactive element to begin the online event, wherein each content block object comprises a content object type and content associated with the content block object, wherein the content block object are displayed in a sequential order;
receiving a selection of the interactive element to begin the online event;
causing the content associated with a first content block object to be displayed through an audio-video communication session, the first content block object being first in the sequential order; and
upon completion of the content associated with the first content block object, causing the content associated with a second content block object to be displayed through the audio-video communication session, the second content block object being after the first content block object in the sequential order.

2. The method of claim 1, further comprising:
receiving, through a user interface of the one or more computing devices, a specification of a new content block object to be added to the plurality of content block objects comprising the online event, wherein the specification of the new content block object comprises:
a content object type,
content associated with the new content block object, and
a position of the new content block object in the sequential order of the plurality of content block objects; and
updating the user interface of the one of the one or more computing devices to include the new content block object at a location corresponding to the position of the new content block object in the sequential order.

3. The method of claim 1, wherein each content block object is further associated with a presenting user, the method further comprising:
upon causing the content associated with a first content block object to be displayed through the audio-video communication session, facilitating audio or video associated with the presenting user associated with the first content block object to be transmitted through the audio-video communication session; and
upon causing the content associated with the second content block object to be displayed through the audio-video communication session, facilitating audio or video associated with the presenting user associated with the second content block object to be transmitted through the audio-video communication session.

4. The method of claim 3, wherein facilitating audio or video associated with a presenting user to be transmitted through the audio-video communication session comprises:
configuring a computing device of the presenting user to capture audio or video data in an environment of the presenting user; and
configuring the computing device of the presenting user to transmit the captured audio or video data through the audio-video communication session.

5. The method of claim 1, wherein each content block object is further associated with a presenting user, the method further comprising:
upon causing the content associated with a first content block object to be displayed through the audio-video communication session, causing an icon corresponding to the presenting user associated with the first content block object to be displayed through the audio-video communication session; and
upon causing the content associated with a second content block object to be displayed through an audio-video communication session, causing an icon corresponding to the presenting user associated with the second content block object to be displayed through the audio-video communication session.

6. The method of claim 1, further comprising:
while the content associated with each content block object is displayed through the audio-video communication session, collecting data associated with one or more participants of the audio-video communication session; and
associating the collected data with the content block object in a database maintained by one of the one or more computing devices.

7. The method of claim 6, further comprising:
retrieving the collected data associated with each content block object of the plurality of content block objects comprising the online event from the database; and
calculating an engagement score for the online event as a weighted combination of scores generated based on the collected data.

8. The method of claim 7, further comprising:
calculating an engagement score for each content block object of the plurality of content block objects comprising the online event, wherein the engagement score for each content block object is based on the content object type of the content block object.

9. The method of claim 7, wherein a type of data collected for each content block object is based on the content object type of the content block object.

10. The method of claim 6, wherein each content block object further comprises a user-notifier, the user-notifier indicating a user to be notified when updated data is collected, the method further comprising:
upon associating the collected data with each content block object in the database maintained by one of the one or more computing devices, sending a notification of new data to a computing device associated with the user indicated in the user-notifier of each content block object.

11. The method of claim 1, wherein the content object type comprises one or more of:
slide-type content;
survey-type content;
media-type content;
screen sharing-type content;
presenter feed-type content; or
whiteboard-type content.

12. The method of claim 1, wherein the online event comprises a video conference, a webinar, a trade show, a mixed-attendance conference, a concert, or a virtual-reality event.

13. One or more non-transitory computer-readable storage media embodying software that is operable when executed to perform operations comprising:
displaying, in a user interface of one or more computing devices, a plurality of content block objects comprising an online event and an interactive element to begin the online event, wherein each content block object comprises a content object type and content associated with the content block object, wherein the content block objects are displayed in a sequential order;
receiving a selection of the interactive element to begin the online event;
causing the content associated with a first content block object to be displayed through an audio-video communication session, the first content block object being first in the sequential order; and
upon completion of the content associated with the first content block object, causing the content associated with a second content block object to be displayed through the audio-video communication session, the second content block object being after the first content block object in the sequential order.

14. The one or more non-transitory computer-readable storage media of claim 13, wherein the software is further operable when executed to do perform operations comprising:
receiving, through the user interface, a specification of a new content block object to be added to the plurality of content block objects comprising the online event, wherein the specification of the new content block object comprises:
a content object type,
content associated with the new content block object, and
a position of the new content block object in the sequential order of the plurality of content block objects; and
updating the user interface of the one of the one or more computing devices to include the new content block object at a location corresponding to the position of the new content block object in the sequential order.

15. The one or more non-transitory computer-readable storage media of claim 13, wherein each content block object is further associated with a presenting user, wherein the software is further operable when executed to perform operations comprising:
upon causing the content associated with a first content block object to be displayed through the audio-video communication session, facilitating audio or video associated with the presenting user associated with the first content block object to be transmitted through the audio-video communication session; and
upon causing the content associated with the second content block object to be displayed through the audio-video communication session, facilitating audio or video associated with the presenting user associated with the second content block object to be transmitted through the audio-video communication session.

16. The one or more non-transitory computer-readable storage media of claim 15, wherein the software operable when executed to facilitate audio or video associated with a presenting user to be transmitted through the audio-video communication session, is further operable when executed to perform operations comprising:
configuring a computing device of the presenting user to capture audio or video data in an environment of the presenting user; and
configuring the computing device of the presenting user to transmit the captured audio or video data through the audio-video communication session.

17. A system comprising:
one or more processors; and
one or more computer-readable non-transitory storage media coupled to one or more of the processors and comprising instructions operable when executed by one or more of the processors to cause the system to perform operations comprising:
receiving a selection of the interactive element to begin the online event;
causing the content associated with a first content block object to be displayed through an audio-video communication session, the first content block object being first in the sequential order; and
upon completion of the content associated with the first content block object, causing the content associated with a second content block object to be displayed through the audio-video communication session, the second content block object being after the first content block object in the sequential order.

18. The system of claim 17, wherein the instructions are further operable when executed by one or more of the processors to perform operations comprising:
receiving, through the user interface, a specification of a new content block object to be added to the plurality of content block objects comprising the online event, wherein the specification of the new content block object comprises:
a content object type,
content associated with the new content block object, and
a position of the new content block object in the sequential order of the plurality of content block objects; and
updating the user interface of the one of the one or more computing devices to include the new content block object at a location corresponding to the position of the new content block object in the sequential order.

19. The system of claim 17, wherein each content block object is further associated with a presenting user, wherein the instructions are further operable when executed by one or more of the processors to cause the system to perform operations comprising:
upon causing the content associated with a first content block object to be displayed through the audio-video communication session, facilitating audio or video associated with the presenting user associated with the first content block object to be transmitted through the audio-video communication session; and
upon causing the content associated with the second content block object to be displayed through the audio-video communication session, facilitating audio or video associated with the presenting user associated with the second content block object to be transmitted through the audio-video communication session.

20. The system of claim 19, where each content block object is further associated with a presenting user, wherein the instructions are further operable when executed by one or more of the processors to cause the system to perform operations comprising:
upon causing the content associated with a first content block object to be displayed through the audio-video communication session, facilitating audio or video associated with the presenting user associated with the first content block object to be transmitted through the audio-video communication session; and
upon causing the content associated with the second content block object to be displayed through the audio-video communication session, facilitating audio or video associated with the presenting user associated with the second content block object to be transmitted through the audio-video communication session.
